(19) United States
(12) Patent Application Publication
(10) Pub. No.: US 2026/0307360 A1
(43) Pub. Date: Oct. 8, 2026

(54) Method for Creating Foamed Pattern on Article

(71) Applicant: CHANCE LINE INDUSTRIAL CO., LTD., Siansi Township (TW)

(72) Inventor: Ming-Hsien YAO, Siansi Township (TW)

(21) Appl. No.: 19/629,100

(22) Filed: Mar. 26, 2026

(30) Foreign Application Priority Data
Apr. 2, 2025 (TW) 114112898

(51) Int. Cl. B32B 5/20; B32B 3/30; B32B 37/12; B32B 37/26; B32B 38/00; B32B 38/06; B32B 38/18

(52) U.S. Cl. CPC B32B 5/20; B32B 3/30; B32B 37/1207; B32B 37/26; B32B 38/0004; B32B 38/004; B32B 38/06; B32B 38/185; B32B 2037/1215; B32B 2037/268; B32B 2307/4026

(57) ABSTRACT

A method for creating a foamed pattern on an article comprises: preparing a foam plotter-cut film and a textured plate, one surface of the textured plate having recessed and raised textures; the foam plotter-cut film having a hot melt adhesive layer and a foam layer; cutting out a pattern from the foam plotter-cut film; hot-pressing the foam plotter-cut film to adhere the pattern onto an article; placing the textured plate on the pattern, so that the recessed and raised textures of the textured plate contacting the pattern; and hot-pressing the textured plate and the pattern to cause the pattern to form a foamed pattern, thereby the recessed and raised textures are formed on a surface of the foamed pattern by means of the textured plate.

### FIELD OF THE INVENTION

The invention relates to a manufacturing method, specifically a method for creating a foamed pattern on a surface of an article.

### DESCRIPTION OF THE RELATED ART

Foam plotter-cut film is available on the market, allowing consumers to create texts or graphic patterns on clothing. Foam plotter-cut film can create foamed patterns, which have a more three-dimensional effect than regular plotter-cut film.

Although foamed patterns offer a more three-dimensional look, the materials provided at retail stores only allow users to create foamed patterns by DIY; the materials cannot enable DIY users to create other effects with foamed patterns, causing inconvenience for DIY enthusiasts.

### SUMMARY OF THE INVENTION

Conventional techniques lack suitable materials that allow users to create textures on foam patterns by DIY. The invention is capable of addressing this drawback. One object of the invention is to provide a method for creating a foamed pattern on an article, enabling DIY users to create various recessed and raised textures on a surface of the foamed pattern by DIY, thereby enhancing both aesthetics and uniqueness of the foamed pattern.

A method for creating a foamed pattern on an article provided by the invention comprises following steps of:
1. preparing a foam plotter-cut film and a textured plate, one surface of the textured plate being a textured surface with recessed and raised textures; the foam plotter-cut film having a hot melt adhesive layer and a foam layer disposed on the hot melt adhesive layer;
2. cutting out a pattern from the foam plotter-cut film and retaining the pattern, the pattern having the hot melt adhesive layer and the foam layer;
3. taking an article and placing the foam plotter-cut film on the article, so that the hot melt adhesive layer of the pattern contacting the article;
4. hot-pressing the foam plotter-cut film to adhere the pattern to the article via the hot melt adhesive layer;
5. placing the textured plate on the pattern, so that the recessed and raised textures of the textured surface contacting the pattern; and
6. hot-pressing the textured plate and the pattern to cause the pattern to form a foamed pattern, a surface of the foamed pattern being formed with recessed and raised textures.

Using the above method, individuals or businesses can create foamed patterns with recessed and raised textures on clothing or various articles. The foamed patterns can be made into various shapes, such as texts or non-text patterns, and the recessed and raised textures made on surfaces of the foamed patterns can enhance both aesthetics and uniqueness of the foamed patterns. Thus, varied foamed patterns can be created on clothing or articles to increase uniqueness or aesthetic appeal of the clothing or articles.

Preferably, the textured plate is made of at least two of following materials: paper fiber, plastic, and calcium carbonate. The textured plate is thin, lightweight, sturdy, and heat-resistant. The recessed and raised textures maintain shapes and will not deform, allowing for repeated use dozens of times. The textured plate is flexible, when the textured plate and the pattern are heated, the recessed and raised textures can conform to a surface of the pattern.

The textured plate and the pattern are heated using a heat-pressing device, causing the pattern to foam. The textured plate is thin, capable of conducting heat fast, and enabling heat to penetrate, enabling a heat energy from the heat-pressing device to be fully applied to the foam layer of the pattern, causing the foam layer to foam.

Preferably, the plastic material of the textured plate is a rigid plastic, such as polypropylene or polyester.

Preferably, the recessed and raised textures of the textured plate are either textures regularly disposed and regularly arranged, or irregularly textures irregularly disposed and irregularly arranged.

Preferably, the textured surface of the textured plate is further disposed with fine recessed and raised textures, so that the foamed pattern, in addition to having the recessed and raised textures, is also formed with the fine recessed and raised textures.

Preferably, the recessed and raised textures of the textured plate can be raised textures, recessed textures, or composite textures with raised textures and recessed textures, thus forming composite textures with raised textures and recessed textures on a surface of the foamed pattern.

Preferably, the foam plotter-cut film further comprises a positioning film; the positioning film is detachably bonded to the foam layer.

Preferably, the foam plotter-cut film comprises the positioning film, such that when cutting out the pattern, a cut line cuts through the hot melt adhesive layer and the foam layer, but not cutting through the positioning film.

Preferably, when retaining the pattern, a waste material other than the pattern is removed, and the pattern is adhered on the positioning film.

Preferably, one surface of the foam layer is in contact with the positioning film, and the surface is glossy, matte, or has a surface treatment effect.

### BRIEF DESCRIPTION OF DRAWINGS

The objects, features, and achieved efficacies of the invention can be understood from the description and drawings of the following preferred embodiments, in which:

FIG. 1 is a foam plotter-cut film used in a manufacturing method of the invention.

FIG. 2 is a cross-sectional view of the foam plotter-cut film of FIG. 1.

FIGS. 3 and 4 are cross-sectional views of a semi-finished product of the foam plotter-cut film of FIG. 1.

FIGS. 5 to 7 show photographs of three textured plates used in the manufacturing method of the invention, with FIGS. 5A to 7A being partially enlarged views of FIGS. 5 to 7 respectively.

FIG. 8 is a cross-sectional view along section line 8-8 of FIG. 5A.

FIG. 9 is a cross-sectional view along section line 9-9 of FIG. 7A.

FIG. 10 is a flowchart of the manufacturing method of the invention.

FIGS. 11 to 19 show a process of manufacturing a foamed pattern on an article according to a preferred embodiment of the invention.

FIG. 20 is a cross-sectional view of a finished product of FIG. 19.

FIGS. 21 to 23 show another three foamed patterns manufactured on articles using the manufacturing method of the invention, with FIGS. 21A to 23A being partially enlarged views of FIGS. 21 to 23 respectively.

### DETAILED DESCRIPTION OF THE INVENTION

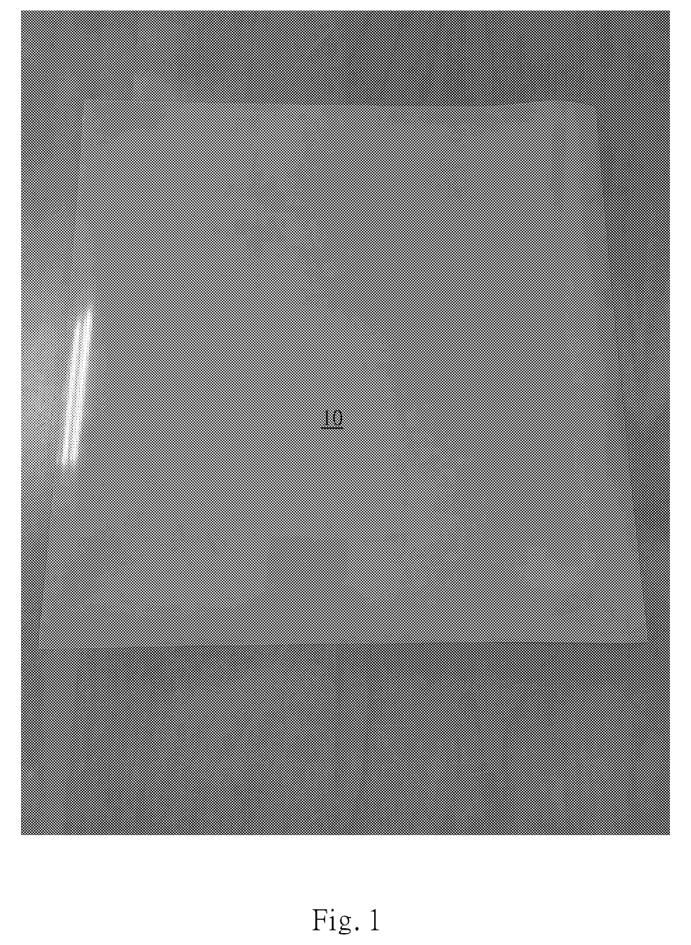

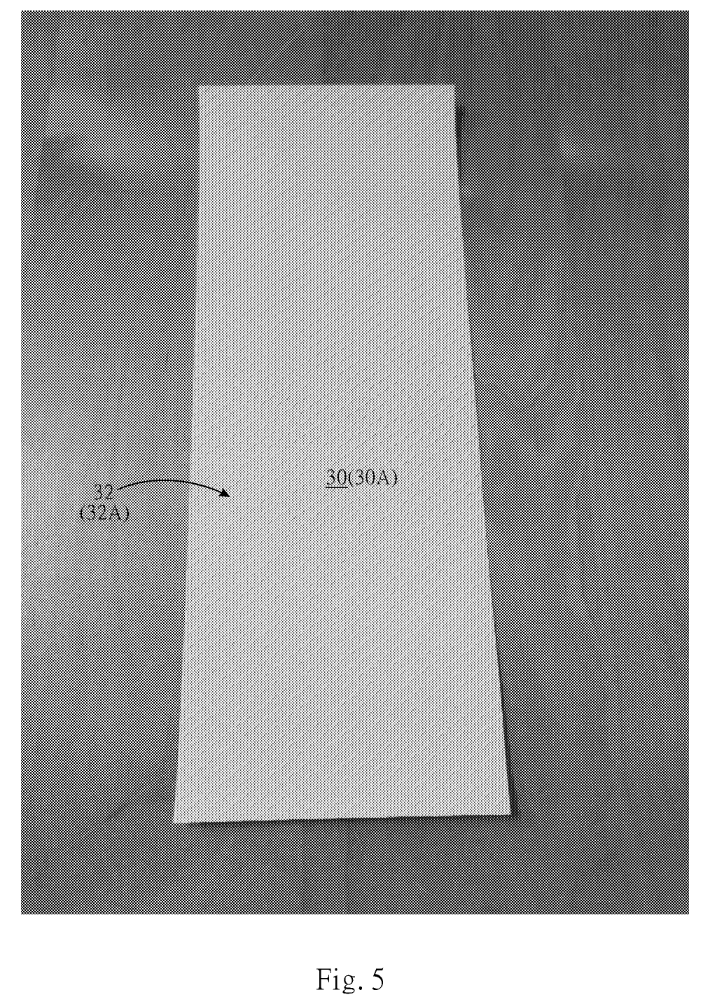

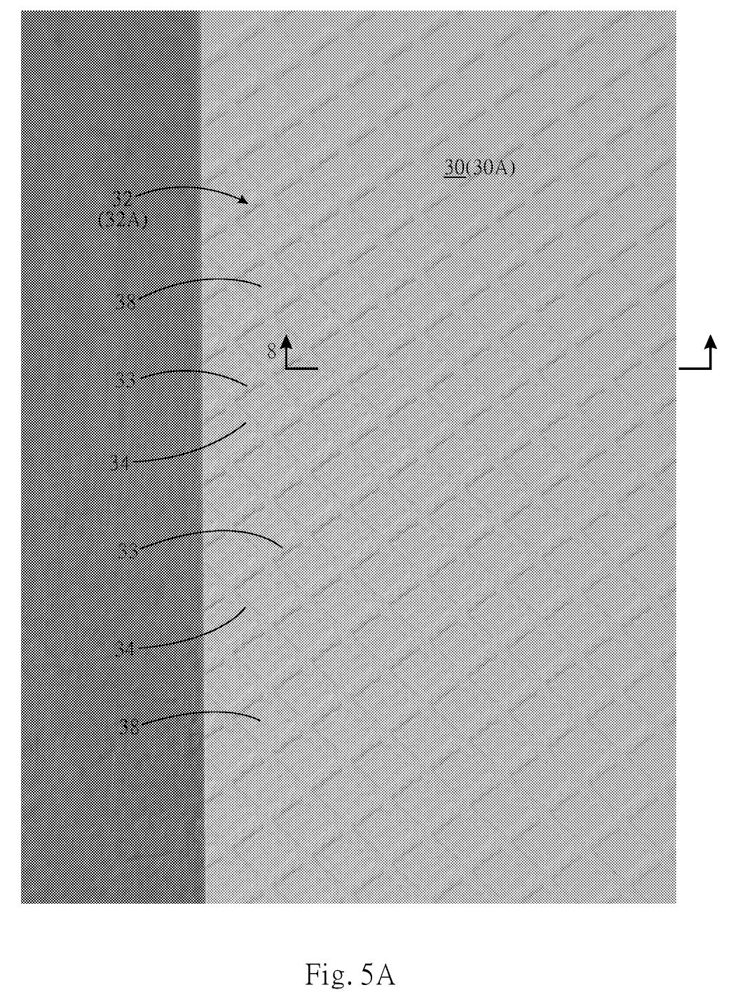

The invention provides a method for creating a foamed pattern on an article, such as on a surface of articles made of various materials including fabric, metal, wood, and plastic. The invention utilizes a foam plotter-cut film 10 shown in FIG. 1 and a rigid textured plate 30 shown in FIG. 5 to create a foamed pattern.

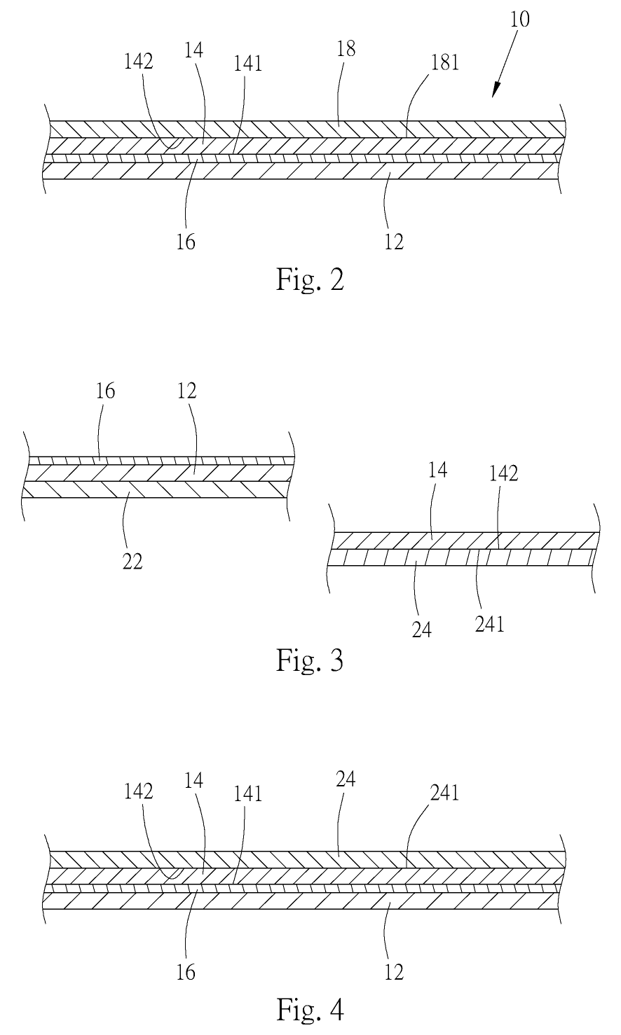

Please refer to FIG. 2. The foam plotter-cut film (hereinafter referred to as the plotter-cut film) 10 comprises: a hot melt adhesive layer 12, a foam layer 14, and a positioning film 18. One surface 141 of the foam layer 14 is an inner surface, which is connected to the hot melt adhesive layer 12 through an adhesive layer 16; another surface 142 of the foam layer 14 is an outer surface, which can be surface treated to have a surface effect, such as a glossy or matte finish, or textured to have textures, such as fine recessed and raised textures. An inner surface 181 of the positioning film 18 is adhesive, enabling the foam layer 14 to be detachably adhered to the positioning film 18. When the foam layer 14 is separated from the positioning film 18, the foam layer 14 can be re-adhered to the positioning film 18 through a viscosity of the inner surface 181 and will remain positioned on the positioning film 18 without moving. A material of the foam layer 14 can be, but is not limited to, various foaming materials such as polyurethane (PU), thermoplastic elastomer (TPE), ethylene-vinyl acetate copolymer (EVA), polystyrene (PS), polyolefin (such as polyethylene (PE), polypropylene (PP)), nitrile butadiene rubber (NBR) or polyvinyl chloride (PVC).

FIGS. 3 and 4 illustrate a manufacturing method of the plotter-cut film 10. Please refer to FIG. 2, firstly, the hot melt adhesive layer 12 is prepared, which can be formed by coating a liquid hot melt adhesive onto a carrier 22, or can be a solid hot melt adhesive layer. Then, the adhesive layer 16 is disposed on one surface of the hot melt adhesive layer 12. A liquid foaming material is coated to a surface 241 of another carrier 24, and allowed to shape to form the foam layer 14. The surface 241 of the carrier 24 has release properties and undergoes surface treatment or texturing treatment. Through the surface 241, the surface 142 of the foam layer 14 achieves the aforementioned glossy finish, matte finish, or textured surface effects. Pigments or dyes can be added to a resin of the foam layer 14 to create foam layers of different colors. The carriers 22, 24 can be polyethylene terephthalate (PET) films.

The foam layer 14 and the hot melt adhesive layer 12 are bonded together by the adhesive layer 16, as shown in FIG. 4. Then, the carrier 24 is removed, and the positioning film 18 is bonded to the outer surface 142 of the foam layer 14, thus forming the plotter-cut film 10 shown in FIG. 2.

The textured plate 30 shown in FIGS. 5 to 7 is a flexible, lightweight, and thin rigid sheet with a thickness of 0.5~1.5 mm, preferably 0.6~1.2 mm. The textured plate 30 is molded and materials thereof comprise paper fiber, rigid plastic, and calcium carbonate. The textured plate 30 is sturdy, flexible, heat-resistant, and reusable. The rigid plastic is, for example, polypropylene (PP) or polyester (PET). One surface of the textured plate 30 is a textured surface with recessed and raised textures 32. The textured plate 30 is lightweight, thin, has fast thermal conductivity, and good heat penetration. Please refer to FIGS. 5 and 5A. A textured plate 30A (30) has two raised lines 33, 34 in different directions, forming regularly disposed and regularly arranged recessed and raised textures 32A (32).

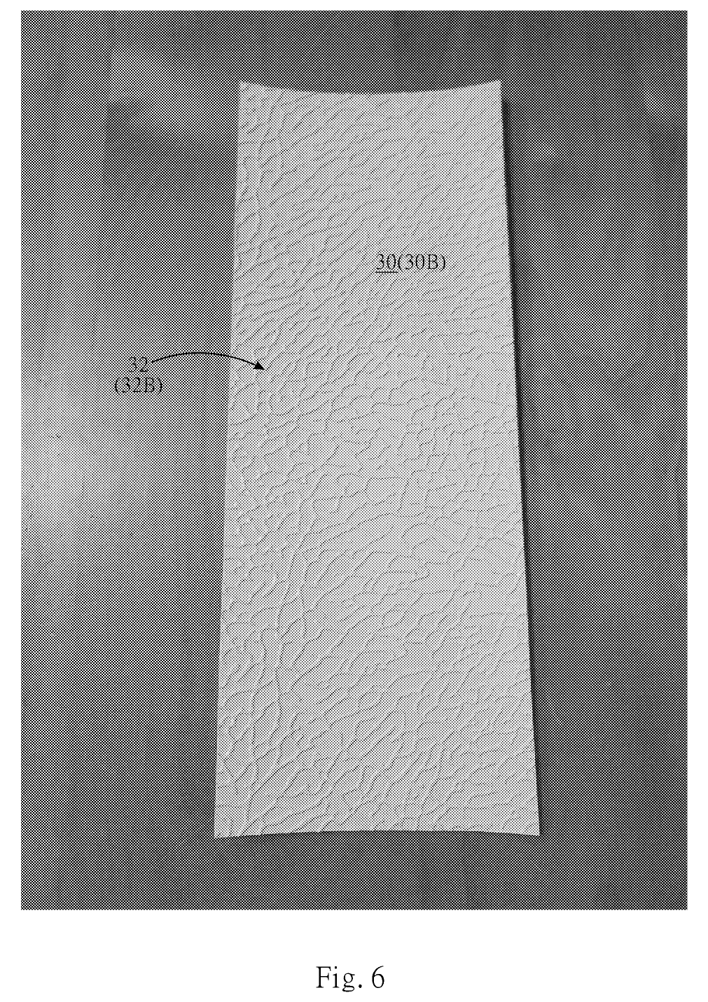

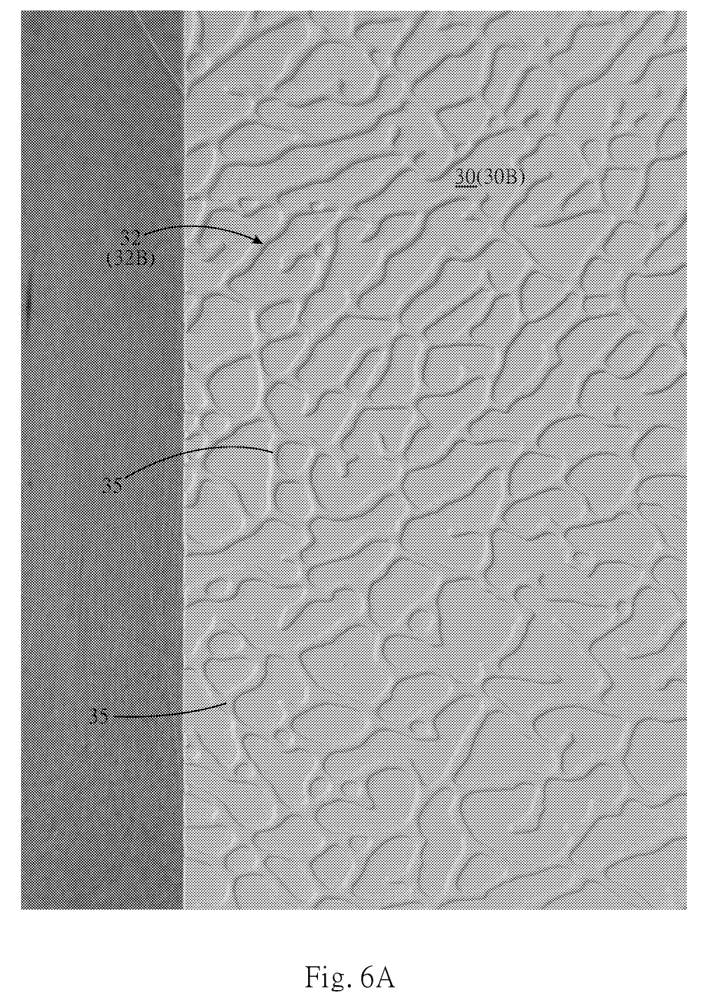

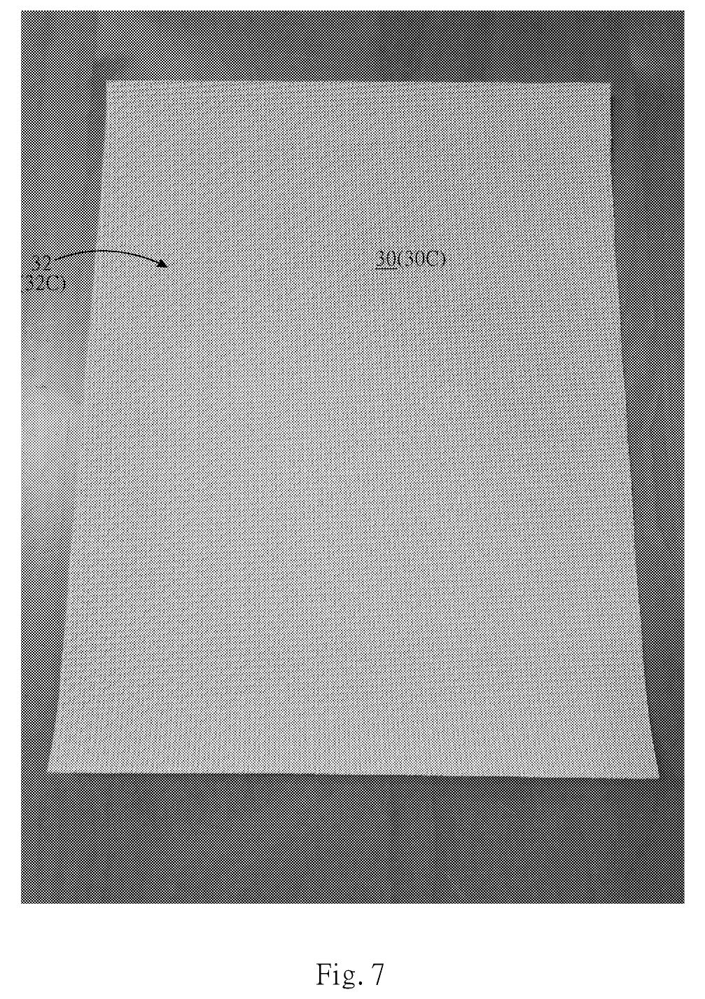

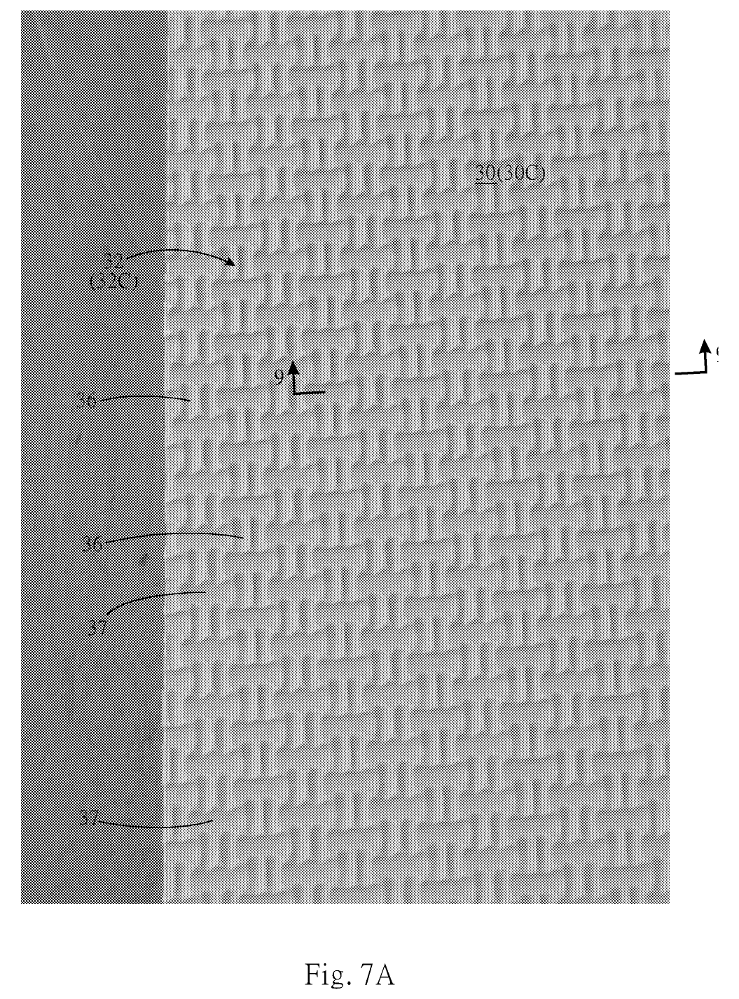

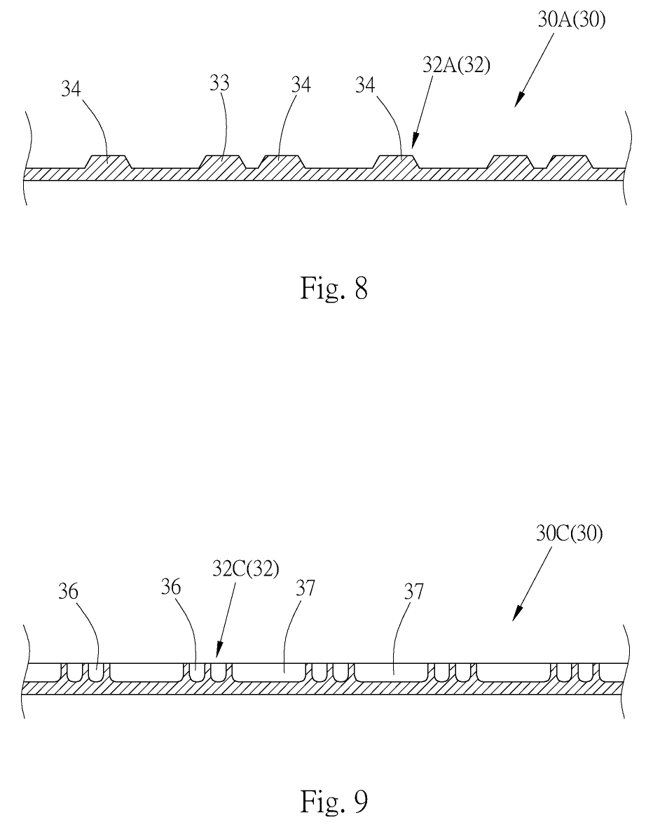

FIGS. 6 and 7 show the other two textured plates 30 (30B, 30C). Please refer to FIGS. 6 and 6A, one surface of the textured plate 30B (30) is created with irregular raised textures 35, forming irregular recessed and raised textures 32B (32). Please refer to FIGS. 7 and 7A, one surface of the textured plate 30C (30) is created with recessed textures 36, 37 in different directions. The recessed textures 36 in one direction are arranged regularly, while the recessed textures 37 in another direction are also arranged regularly, forming regular textures 32C (32). It is understood that the recessed and raised textures 32A to 32C of the three textured plates are merely examples, not limitations, various regular or irregular recessed and raised textures 32 can be created. The textured plate 30 is sturdy, and the recessed and raised textures 32 can maintain shapes and will not deform. FIG. 8 shows a cross-sectional view of the textured plate 30A (30) of FIG. 5A, where the raised lines 33, 34 form the recessed and raised textures 32A (32). FIG. 9 shows a cross-sectional view of the textured plate 30C (30) of FIG. 7A, where the recessed and raised textures 32C (32) are formed by the recessed textures 36, 37. It is understood that the lines and textures (33, 34, 35) of the textured plates 30A, 30B can be made into recessed lines and textures, while the recessed textures (36, 37) of the textured plate 30C can be made into raised lines. In addition, the recessed and raised textures 32 of the textured plate 30 can be raised textures, recessed textures, or composite textures with raised textures and recessed textures.

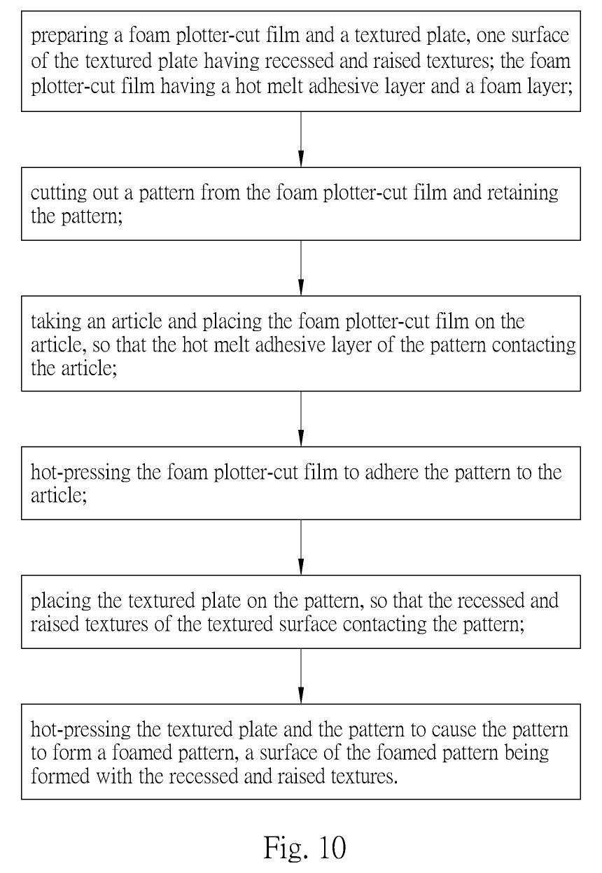

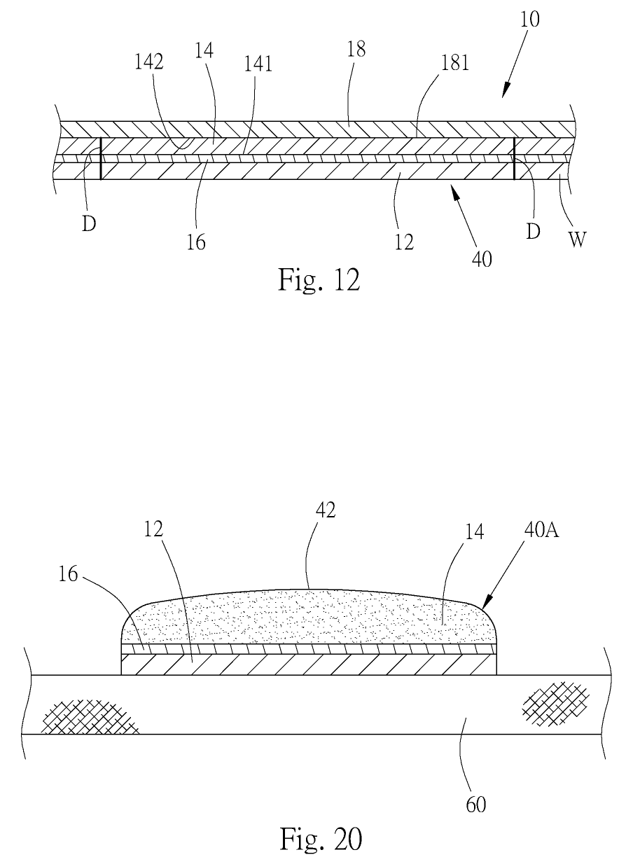

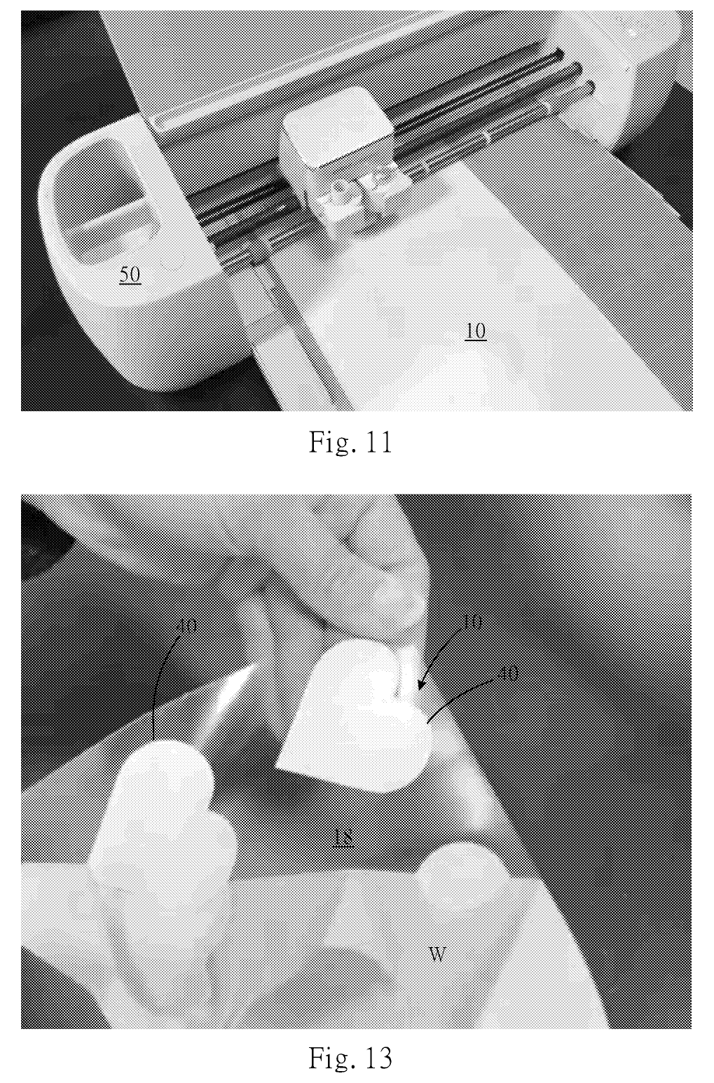

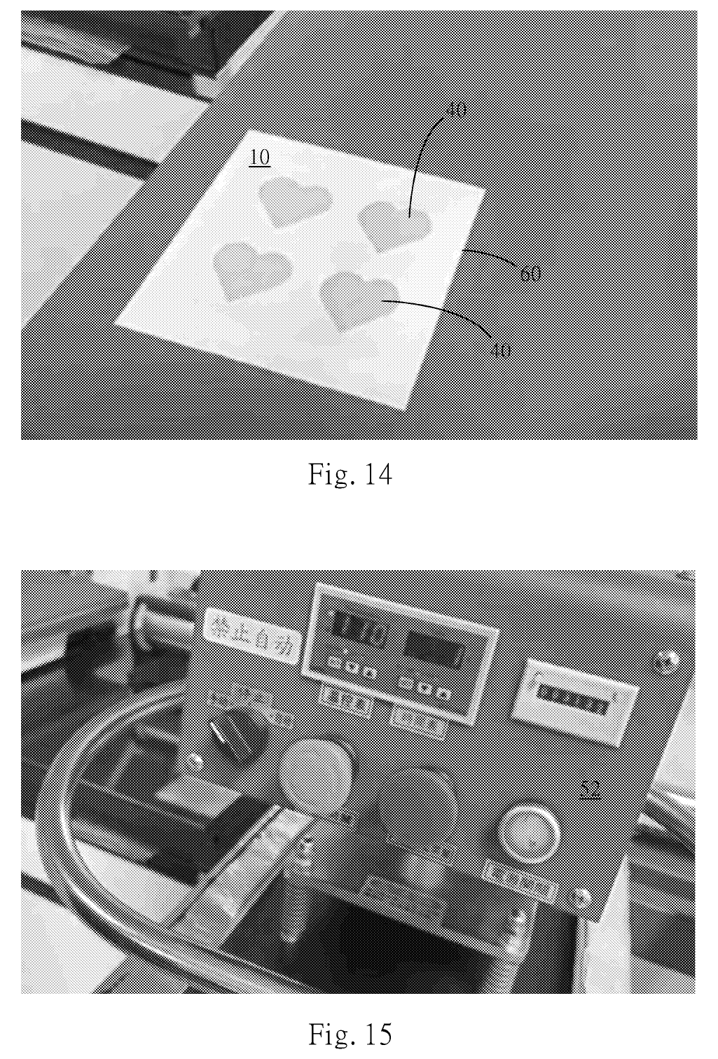

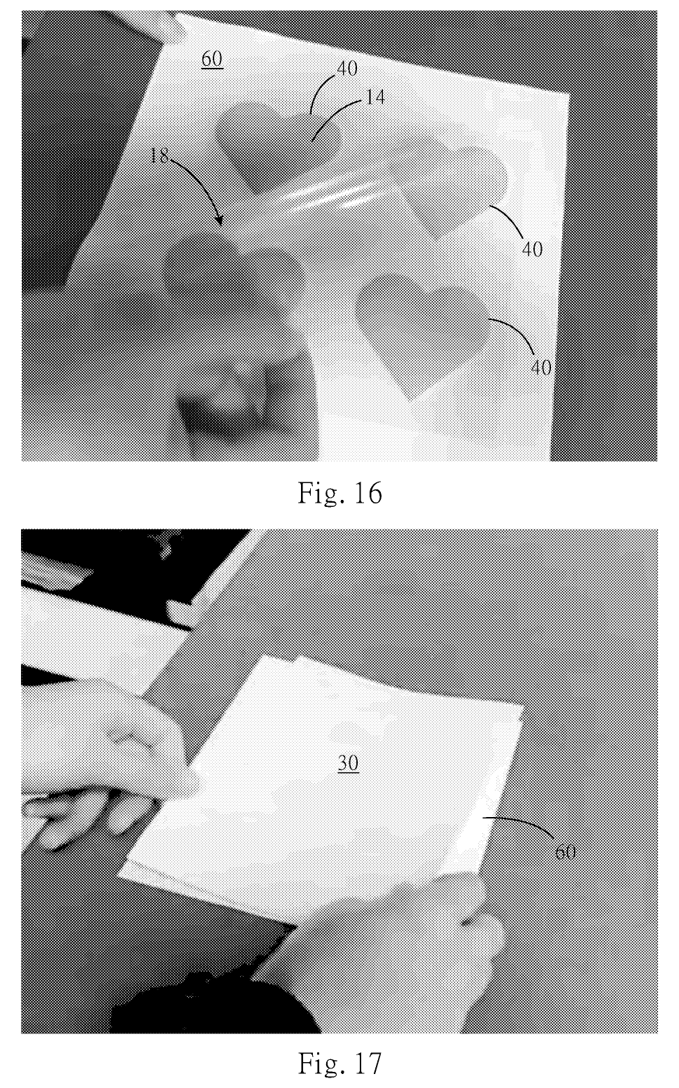

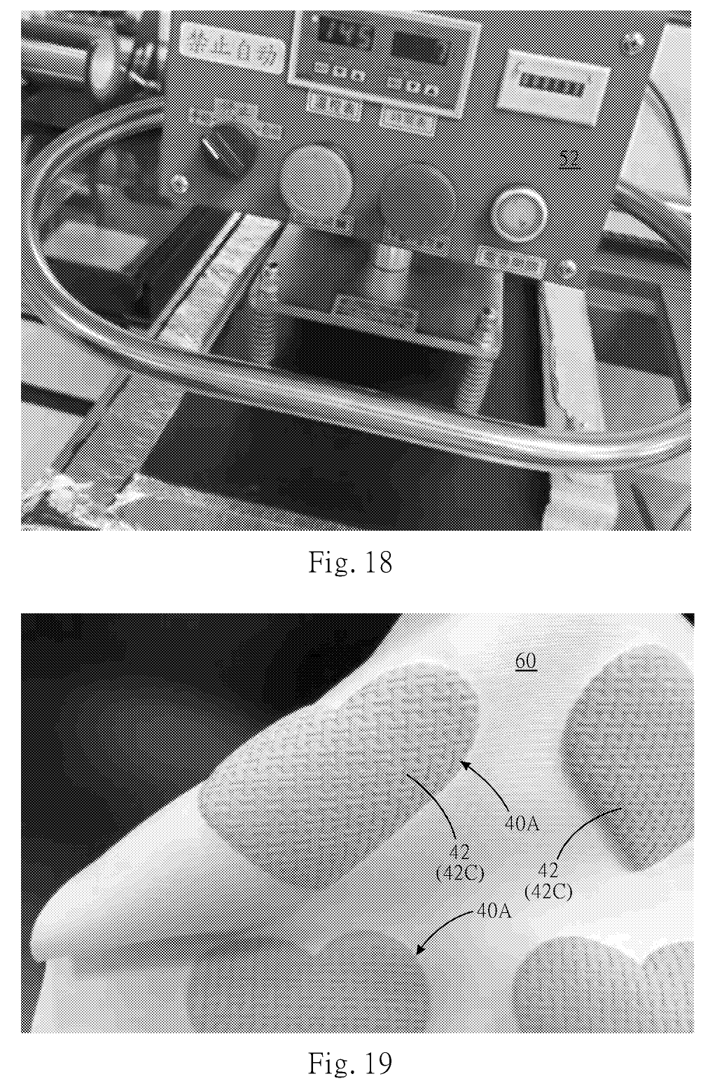

The invention enables the general public or businesses to create foamed patterns on an article themselves (DIY), such as creating foamed patterns on clothing, to enhance aesthetics, decorative effects, and uniqueness of articles. A flowchart of the invention is shown in FIG. 10, and the following description, in conjunction with FIGS. 11 to 19, illustrates a process of creating foamed patterns on a fabric according to the invention.
1. Firstly, preparing the foam plotter-cut film 10 as shown in FIGS. 1 and 2, and the textured plate 30, as shown in any one of FIGS. 5 to 7.
2. Cutting out a pattern from the plotter-cut film 10. The cut pattern can be texts (e.g., characters from various countries) or non-texts (e.g., people, landscapes, objects, symbols, etc.). As shown in FIG. 12, in this preferred embodiment, a pattern 40 cut out is a heart shape as an example, with the four heart-shaped patterns 40 cut out from the plotter-cut film 10. Please refer to FIG. 12, a cut line D of the pattern 40 cuts through the hot melt adhesive layer 12, the adhesive layer 16 and the foam layer 14, but not cutting through the positioning film 18. A user can cut the pattern 40 manually, or, as shown in FIG. 11, use a home cutting machine 50 to cut out the pattern 40 from the plotter-cut film 10.
3. After cutting, removing a waste material W other than the pattern 40, as shown in FIG. 13, leaving only the pattern 40 on the plotter-cut film 10. At this time, the pattern 40 is adhered on the positioning film 18.
4. Taking an article and heat-pressing the pattern 40 onto a surface of the article.
   As shown in FIG. 14, take a fabric 60 and place the plotter-cut film 10 with the waste material W removed in FIG. 13 on the fabric 60. The hot melt adhesive layer 12 of the pattern 40 is in contact with the fabric 60, and the positioning film 18 faces outwards. Then, a user can use a household iron or a heat press 52 to heat press the plotter-cut film 10 at a first temperature for an appropriate time length, as shown in FIG. 15. The heat pressing temperature is 100~125℃, for example, 110℃. After heat pressing, the heated hot melt adhesive layer 12 generates viscosity, causing the pattern 40 to adhere to a surface of the fabric 60.
5. After completing heat pressing operation, peeling off the positioning film 18, as shown in FIG. 16, exposing the foam layer 14 of the pattern 40.
6. Please refer to FIG. 17, placing the textured plate 30 on the fabric 60, with the recessed and raised textures 32 of the textured plate 30 contacting the pattern 40 on the fabric 60. Then, as shown in FIG. 18, heat pressing the textured plate 30 and the pattern 40 at a second temperature for an appropriate time length using a household iron or the heat press 52, causing the foam layer 14 of the pattern 40 to foam. The heat pressing temperature is 125~165° C, for example, 145° C. After heat pressing, the foam layer 14 of the pattern 40 foams and expands, forming a foamed pattern 40A, as shown in FIGS. 19, 20.

The textured plate 30 is lightweight, thin, and has excellent thermal conductivity and thermal permeability. The textured plate 30 does not impede a heat energy of a heat pressing device, allowing the heat energy and temperature of the heat pressing device to be fully applied to the foam layer 14 of the pattern 40A, enabling the foam layer 14 to complete a foaming process.

After the pattern 40A is foamed, a surface thereof is formed with recessed and raised textures 42. The recessed and raised textures 42 are formed by the recessed and raised textures 32 of the textured plate 30, and raised and recessed shapes of the recessed and raised textures 42 are mirror images of raised and recessed shapes of the recessed and raised textures 32. The recessed and raised textures 42 (42C) of the foamed pattern 40A in FIG. 19 are formed by the recessed and raised textures 32 (32C) of the textured plate 30 (30C) in FIG. 7A.

The textured plate 30 is sturdy yet flexible. When the textured plate 30 and the pattern 40 are heated, the textured plate 30 is able to conform to a surface of the pattern 40, enabling a surface of the foamed pattern 40A to form the clear and complete recessed and raised textures 42.

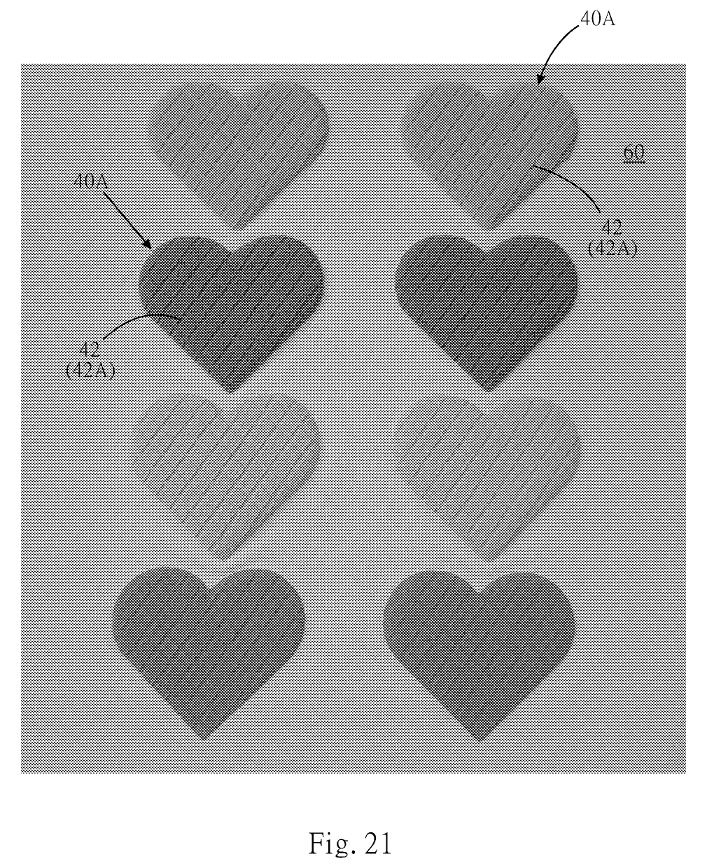

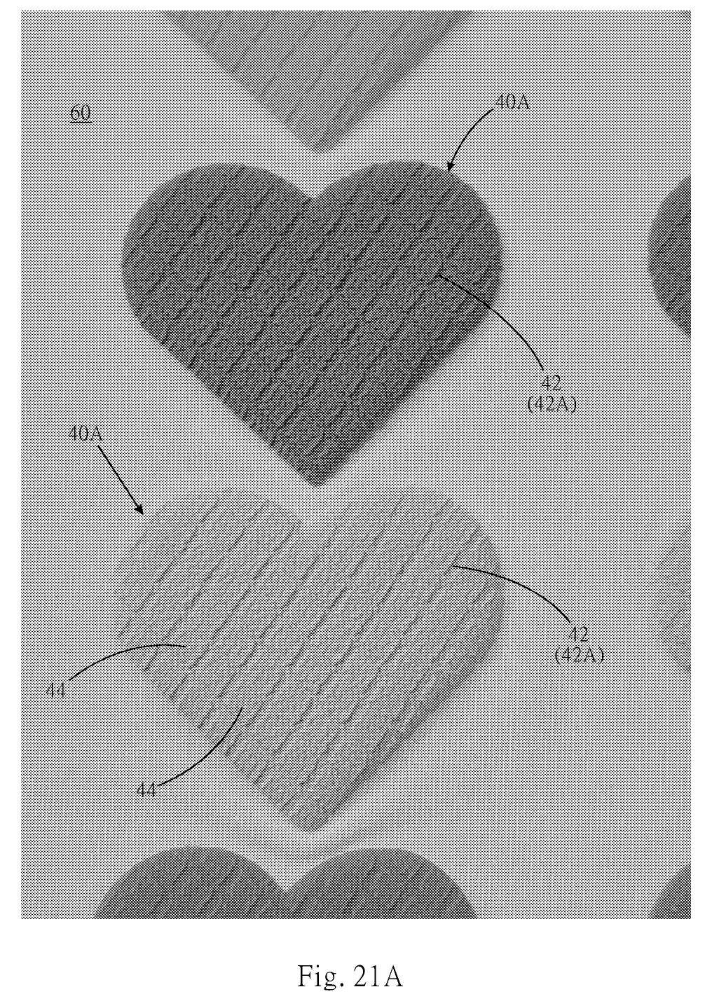

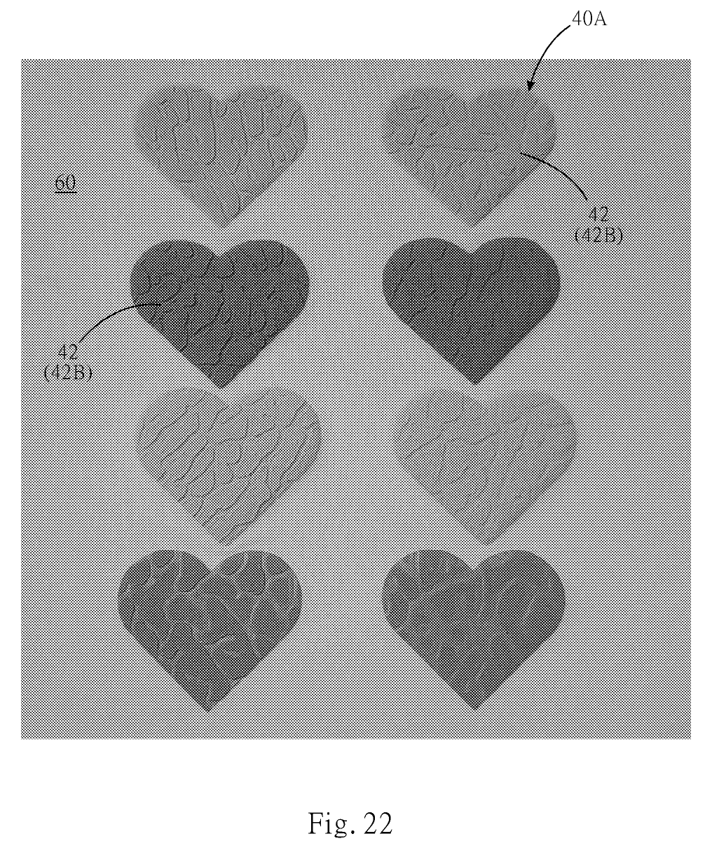

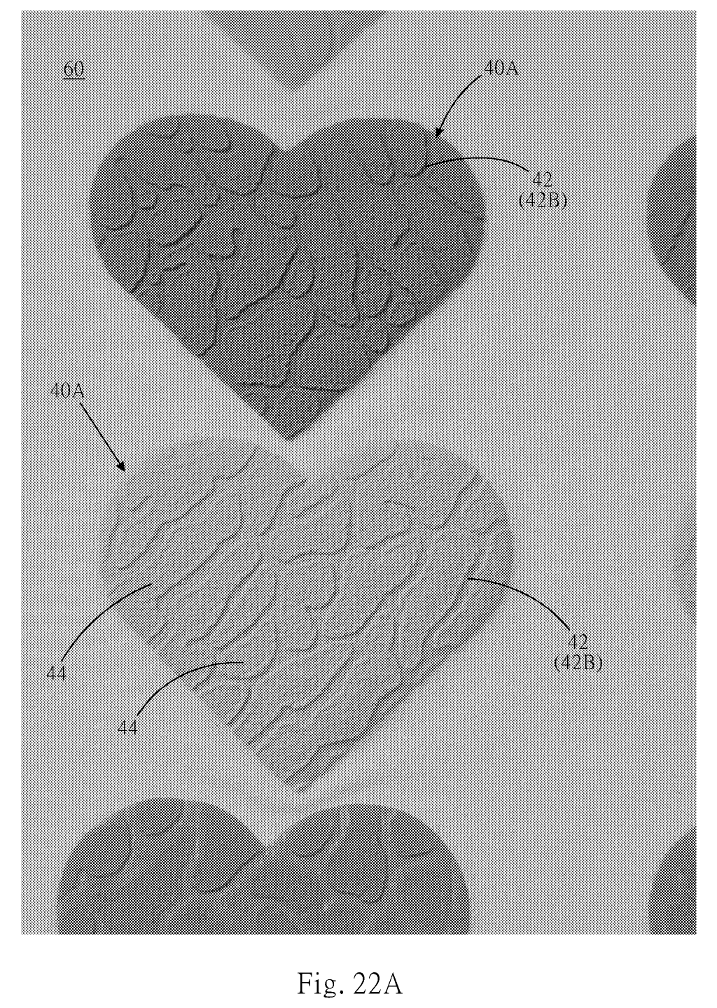

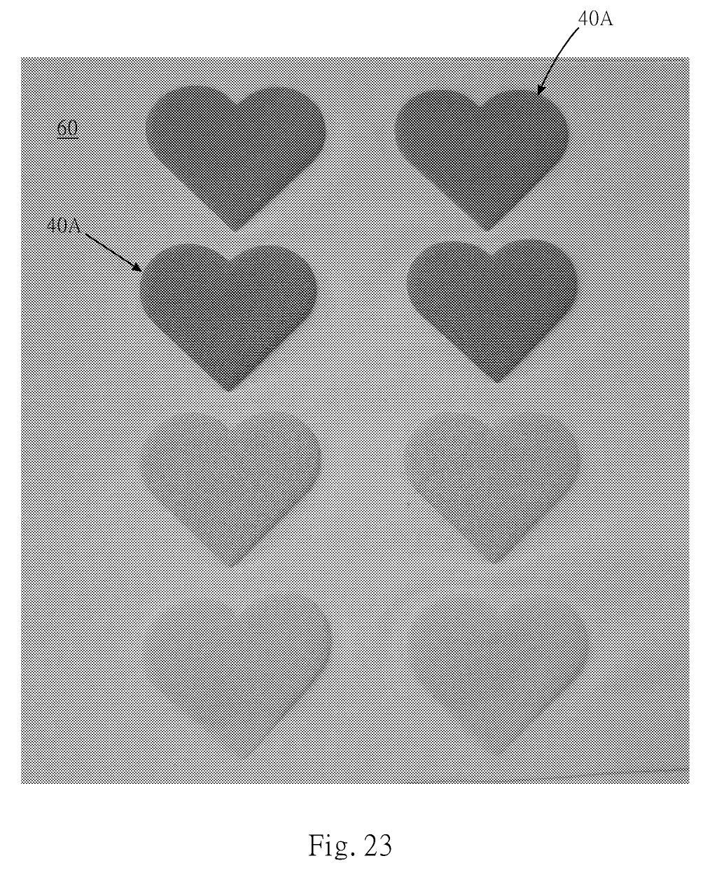

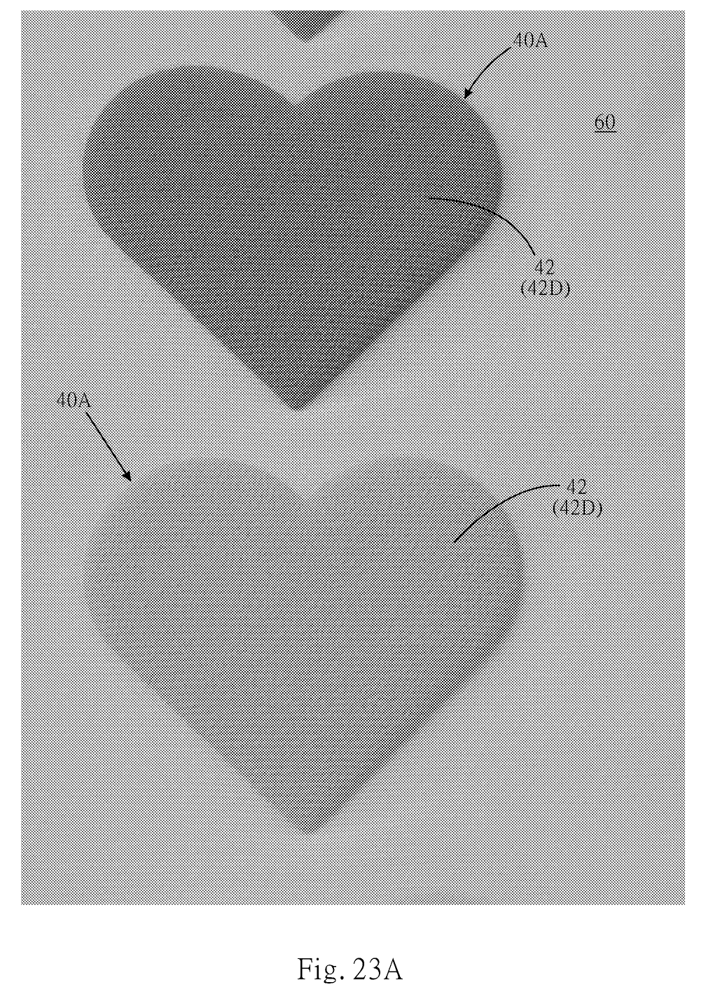

FIGS. 21 to 23A show the other three fabrics 60, a surface of each of the three fabrics 60 has the foamed pattern 40A manufactured using the manufacturing method of the invention. Wherein the recessed and raised textures 42 (42A) on a surface of the foamed pattern 40A in FIGS. 21 and 21A are formed by the recessed and raised textures 32 (32A) of the textured plate 30 (30A) in FIG. 5. The recessed and raised textures 42 (42B) on a surface of the foamed pattern 40A in FIGS. 22 and 22A are formed by the recessed and raised textures 32 (32B) of the textured plate 30 (30B) in FIG. 6. FIGS. 23 and 23A show that the foamed pattern 40A has a different type of the recessed and raised textures 42 (42D) on a surface thereof.

FIGS. 21A and 22A show that, in addition to the recessed and raised textures 42, a surface of the foamed pattern 40A also has fine recessed and raised textures 44. The fine recessed and raised textures 44 of the foamed pattern 40A can be formed by fine recessed and raised textures 38 (as shown in FIG. 5A) created on a textured surface of the textured plate 30, or formed by surface treatment of the outer surface 142 of the foam layer 14. The fine recessed and raised textures 38 can be partially disposed on a textured surface of the textured plate 30, or can cover the entire textured surface, including disposing on surfaces of the raised lines 33, 34, the raised textures 35 and the recessed textures 36, 37.

When the recessed and raised textures 32 of the textured plate 30 are composite textures with recessed textures and raised textures, a surface of the created foamed pattern 40A also has both recessed and raised textures.

The manufacturing method provided by the invention enables users to create the foamed pattern 40A with recessed and raised textures on articles. Varied shapes and textures on a surface of the foamed pattern 40A can be decided by users, resulting in a rich variety of foamed patterns and enhancing both aesthetics and uniqueness of articles such as clothing, leather goods, bags, and shoes. The foamed pattern 40A can be made in different colors, as shown in FIGS. 21 to 23A.

The textured plate 30 is an article developed by the invention, enabling users to create recessed and raised textures on a surface of the foamed pattern 40A. The textured plate 30 is lightweight, easy to use, and does not pose a risk of injury or damage to human body, and can be reused dozens of times.

Although the invention has been disclosed as above with the embodiments, they are not intended to limit the invention. A person having ordinary skill in the art to which the invention pertains can make various changes and modifications without departing from the spirit and scope of the invention. Therefore, the scope of protection of the invention shall be subject to what is defined in the pending claims.

What is claimed is:

1. A method for creating a foamed pattern on an article comprising following steps of:
1. preparing a foam plotter-cut film and a textured plate, one surface of the textured plate being a textured surface with recessed and raised textures; the foam plotter-cut film having a hot melt adhesive layer and a foam layer disposed on the hot melt adhesive layer, the foam layer being capable of foaming when being heated;
2. cutting out a pattern from the foam plotter-cut film and retaining the pattern, the pattern having the hot melt adhesive layer and the foam layer;
3. taking an article and placing the foam plotter-cut film on the article, so that the hot melt adhesive layer of the pattern contacting the article;
4. heating the foam plotter-cut film to adhere the pattern to the article via the hot melt adhesive layer;
5. placing the textured plate on the pattern, so that the recessed and raised textures of the textured plate contacting the pattern; and
6. heating the textured plate and the pattern to cause the foam layer of the pattern to foam, the pattern forming a foamed pattern, a surface of the foamed pattern being formed with recessed and raised textures.

2. The method as claimed in claim 1, wherein the textured plate is made of at least two of following materials: paper fiber, plastic, and calcium carbonate.

3. The method as claimed in claim 2 wherein the plastic material is a rigid plastic.

4. The method as claimed in claim 1, wherein the recessed and raised textures of the textured plate are raised textures, recessed textures, or composite textures with raised textures and recessed textures.

5. The method as claimed in claim 1, wherein the surface of the textured plate having the recessed and raised textures is a textured surface, the textured surface has fine recessed and raised textures.

6. The method as claimed in claim 1, wherein the recessed and raised textures of the textured plate are regular textures or irregular textures.

7. The method as claimed in claim 1, wherein the textured plate is sturdy and flexible.

8. The method as claimed in claim 1, wherein the foam plotter-cut film comprises a positioning film, the positioning film is detachably bonded to the foam layer; when cutting out the pattern in step 2, a cut line cuts through the hot melt adhesive layer and the foam layer, but not cutting through the positioning film.

9. The method as claimed in claim 1, wherein when retaining the pattern in step 2, the pattern is adhered on the positioning film.

10. The method as claimed in claim 1, wherein one surface of the foam layer is in contact with the positioning film, and the surface is glossy, matte, or has a surface treatment.

11. The method as claimed in claim 1, wherein the foam layer contains pigments or dyes.

12. The method as claimed in claim 1, wherein the foamed pattern is made in different colors.
